(19) United States
(12) Patent Application Publication
(10) Pub. No.: US 2025/0265829 A1
(43) Pub. Date: Aug. 21, 2025

(54) EVALUATING NEURAL NETWORK PREDICTION CONFIDENCE USING GENERATIVE RECONSTRUCTION OF TEST IMAGE

(71) Applicant: Merck Sharp & Dohme LLC, Rahway, NJ (US)

(72) Inventors: Antong Chen, Blue Bell, PA (US); Rajath Elias Soans, Atlanta, GA (US); Lillie Evelyn Shelton, Philadelphia, PA (US)

(21) Appl. No.: 19/055,769

(22) Filed: Feb. 18, 2025

Related U.S. Application Data
(60) Provisional application No. 63/554,725, filed on Feb. 16, 2024.

(51) Int. Cl. G06V 10/776; G06T 7/00; G06T 7/194; G06T 11/00; G06V 10/26; G06V 10/36; G06V 10/74; G06V 10/774; G06V 10/82; G06V 20/70

(52) U.S. Cl. CPC G06V 10/776; G06T 7/0014; G06T 7/194; G06T 11/00; G06V 10/26; G06V 10/36; G06V 10/761; G06V 10/774; G06V 10/82; G06V 20/70; G06T 2207/20081; G06T 2207/20084; G06T 2207/20132; G06T 2207/30024; G06T 2210/22; G06T 2210/41; G06V 2201/03

(57) ABSTRACT

A system and method are disclosed for evaluating neural network prediction by leveraging generative reconstructions of a test image to assess confidence in the prediction. The system obtains a test image of a tissue histology slide. The system generates seeds from applying a dropout filter to the test image. The system generates, for each seed, a synthetic image by applying an image generator model to the seed. The system applies a prediction model (e.g., a neural network) to the test image to generate a prediction for the test image of whether the tissue is normal or anormal. The system applies the prediction model to each synthetic image to generate a prediction for the synthetic image of whether the tissue is normal or anormal. The system determines a final prediction for the test image and a confidence associated with the final prediction based on the predictions for the test image and the synthetic images. The system may augment the test image with a label indicating the final prediction and the confidence associated with the final prediction.

### CROSS-REFERENCE TO RELATED APPLICATION(S)

The present application claims the benefit of U.S. Provisional Patent Application No. 63/554,725, filed on Feb. 16, 2024, which is incorporated by reference.

### BACKGROUND

### 1. Technical Field

The subject matter described relates generally to determining the confidence in predictions made by neural network models.

### 2. Background Information

Tissue histology images afford a high-resolution microscopic examination of biological tissue structures, yielding significant advantages in identifying anomalous tissues. They provide a detailed visualization of cellular structures and tissue architecture, which is indispensable for disease detection and diagnosis, notably in cases such as cancers characterized by distinct cellular anomalies. Furthermore, the incorporation of digital image processing and machine learning algorithms lends an objectivity to the approach, mitigating potential human error and ensuring consistent data interpretation. Histological imaging goes beyond simple visual assessment by delivering quantitative data-coupled with the right digital tools, crucial metrics like cell density, size, shape, texture, and color can be quantified, providing a measure of abnormality in a precise, effective, and efficient manner. Anomaly detection models have proved powerful in discriminating normal tissue from abnormal tissue. However, one challenge arises in providing classification confidence assessments for the predictions.

Previously, Bayesian ensembling was employed which trains multiple instances of a neural network employing unique dropout masks and amalgamating their predictions to yield uncertainty estimates. This approach is predicated on the utilization of dropout during inference and the execution of multiple forward passes. Similarly, another method called Bayesian active learning by disagreement (BALD) utilizes dropout during inference to calculate uncertainty estimates and involves the selection of samples that have the highest mutual information between the model's parameters and the target labels. Both works employ generative methods to introduce variations in the model's predictions and estimate uncertainties, thus forming the backbone of contemporary approaches to addressing the challenge of uncertainty determination.

### SUMMARY

The above and other problems can be addressed using a generative model. The generative component is first trained to reconstruct images using a training data distribution. Then, the trained generative component is used to generate synthetic (e.g., full-scale) images from seeds derived from a test image. The discriminative component is then applied to each synthetic image to generate a prediction. The amalgamation of the predictions (e.g., classification labels or values) is used in the determination of the discriminative component's confidence.

The proposed method instead relies on generating a population around the input data point. This helps in better explainability and offers more visualization into what is categorized as relevant population group. Previous methods relied on masking a subset of connections in the neural network, thereby only creating an effect of processing a population by varying the subset of connections that are dropped out in each forward pass.

Furthermore, the methodology grants deep learning tools the ability to assess the certainty of their predictions, allowing them to denote their corresponding model certainty levels. Building upon a pioneering idea from 2015 that utilizes Bayesian probability theory to model a Gaussian process within the neural network of a model, this approach further expands this concept by modeling uncertainty via neural network dropouts during inference, thereby simulating a multitude of predicted decisions produced by the model. This method is applicable to any predictive context. For example, this method can be applied to anomaly detection framework in digital pathology, which would provide pathologists and scientific researchers the ability to rank, sift, or prioritize case studies based on these confidence evaluations.

### BRIEF DESCRIPTION OF THE DRAWINGS

FIG. 1 is a block diagram of a networked computing environment suitable for predicting labels of images, according to one or more embodiments.

FIG. 2 is a block diagram of the analytics system of FIG. 1, according to one or more embodiments.

FIG. 3 illustrates a workflow for anomalous tissue classification with generative reconstruction, according to one or more embodiments.

FIG. 4 illustrates a flowchart of training an image generator model, according to one or more embodiments.

FIG. 5 illustrates a flowchart of training an anomaly classification model, according to one or more embodiments.

FIG. 6 illustrates a flowchart of model deployment, according to one or more embodiments.

FIG. 7 is a plot of confidence output by the models for a validation set of images, according to one or more example implementations.

FIG. 8 is a block diagram illustrating an example of a computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Example Networking Environment

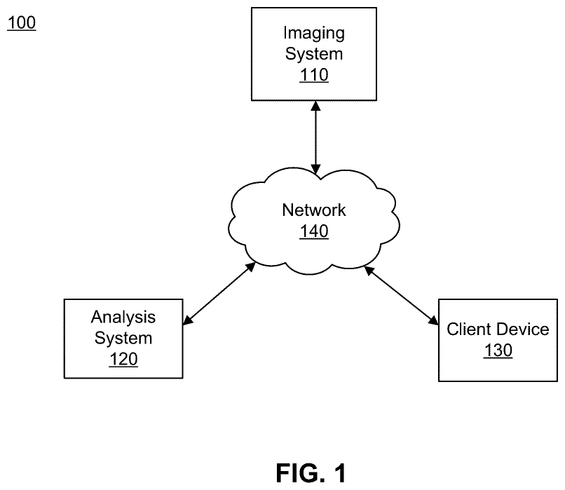

FIG. 1 is a block diagram of a networked computing environment 100 suitable for predicting labels for images, according to one or more embodiments. In the embodiment shown, the networked computing environment includes an imaging system 110, an analytics system 120, and a client device 130, all connected via a network 140. In other embodiments, the networked computing environment 100 includes different or additional elements. In addition, the functions may be distributed among the elements in a different manner than described. Furthermore, in another embodiment, the described functionality may be performed by a single computing device that is not connected to a network.

The imaging system 110 generates imaging data. The imaging device may include at least a lens assembly and an imaging sensor. The lens assembly may direct light from the environment to the imaging sensor. The lens assembly may further magnify or otherwise condition the light. The imaging sensor converts light incident on the sensor into an electrical signal reflecting the intensity of the incident light. The electrical signals together represent an image, e.g., each pixel in the image corresponds to the electrical signal generated by the imaging sensor. In one embodiment, the imaging system 110 may be implemented in real-world contexts, such as capturing images of an outdoor environment to detect objects entering a field of view of the imaging system 110.

In one or more embodiments, the imaging system includes an imaging device for capturing images of tissue histology slides. In such embodiments, the imaging system may automate one or more steps in the workflow for capturing tissue histology slides. The tissue histology workflow generally includes sample collection, sample preparation, staining, and imaging. To collect the sample, a healthcare provider (or an automated surgical system) may collect tissue from a subject. The collected tissue is sliced thinly and affixed to an imaging medium, e.g., a glass slide. To stain the tissue, the tissue is treated with one or more dyes (e.g., hematoxylin and eosin) to visually distinguish cellular structure in the issue. The treated tissue on the slide is imaged by the imaging system, yielding a digital image of the tissue histology slide. Diagnoses of the subject may be used as labels for the tissue histology slides.

The analytics system 120 analyzes the imaging data from the imaging system 110. The analytics system 120 performs one or more analyses to the image data. One example analysis includes predicting a label and/or a score for the image with a confidence evaluation. For example, the analytics system 120 may utilize a model to classify emotions expressed by human subjects captured in the image data with classification confidence. As another example, the analytics system 120 utilizes a model to detect anomalous tissue from tissue histology images and to evaluate the classification confidence. The model may include a generative component and a discriminative component. The generative component generates reconstructed images from cropped portions of the input image. The discriminative component classifies each reconstructed image. The analytics system 120 determines the aggregate classification and the classification confidence based on the classification results.

The client device 130 is a computing device with which a user may interact with the other elements of the networked computing environment (e.g., a terminal, laptop, tablet, smartphone, or any other suitable computing device). In one embodiment, a may use the client device 130 to initiate image capture by the imaging system 110, view the results generated by the analytics system 120, or both. Similarly, the client device 130 may be used to configure the imaging system 110, the analytics system 120, or both (e.g., to provide an updated classifier or set parameters for imaging).

The network 140 provides the communication channels via which the other elements of the networked computing environment 100 communicate. The network 140 can include any combination of local area and wide area networks, using wired or wireless communication systems. In one embodiment, the network 140 uses standard communications technologies and protocols. For example, the network 140 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 140 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 140 may be represented using any suitable format, such as hypertext markup language (HTML) or extensible markup language (XML). In some embodiments, some or all of the communication links of the network 140 may be encrypted using any suitable technique or techniques.

### Analytics System Architecture

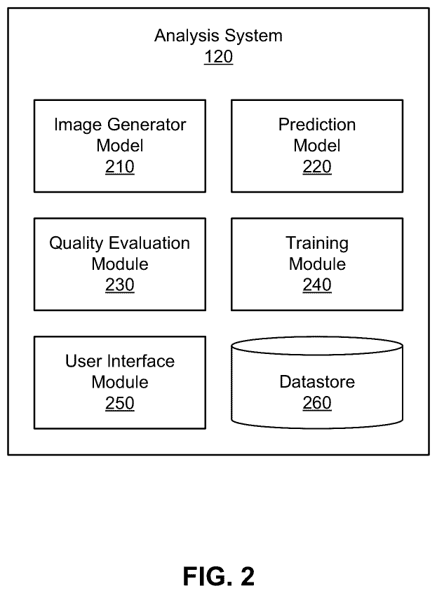

FIG. 2 illustrates one embodiment of the analytics system 120 in greater detail. In the embodiment shown, the analytics system 120 includes an image generator model 210, a prediction model 220, a quality evaluation module 230, a training module 240, a user interface module 250, and a datastore 260. In other embodiments, the analytics system 120 includes different or additional elements. In addition, the functions may be distributed among the elements in a different manner than described.

The image generator model 210 generates reconstructed images from the input image. The image generator model 210 takes the input image and creates seeds from applying a dropout filter to the input image. The dropout filter masks or obscures information in the input image. For example, the dropout filter may crop different portions of the input image to form a seed from one patch of the input image. In another example, the dropout filter may apply a binary mask that drops pixels in the input image (i.e., a value of 1 carries through the pixel data, whereas a value of 0 drops out the pixel data). The image generator model 210 may select from portions of the image pertaining to a target object in the image, e.g., the image generator model 210 may determine a border around the object and select cropped portions from within the border. Accordingly, the image generator model 210 may include a semantic segmentation model to separate pixels related to background and pixels related to the target object. The semantic segmentation model may be a machine-learning model, e.g., a deep-learning neural network. The image generator model 210 applies an image generator model to each seed to generate a reconstructed full-scale image, e.g., of the same dimension as the input image. The image generator model may be a machine-learning model.

In one or more embodiments, the image generator model 210 includes at least a generative layer for reconstructing the input image, yielding a synthetic image, based on the seed. In one or more embodiments, the generative layer may be a generative adversarial network. In other embodiments, the generative layer may be a variational autoencoder, a diffusion model, an autoregressive model, a flow-based model, another deep-learning generative model, or some hybrid thereof. In some embodiments, the image generator model 210 further includes an autoencoder configured to encode an input seed into a latent vector. In some embodiments, during inference, the dropout filter may be applied to the latent vector.

The prediction model 220 classifies an image to output a prediction based on the information in the image. For example, the prediction may be a label (e.g., normal tissue, anormal tissue). Other label classifications may be used: normal tissue v. metastatic tissue; normal lung tissue, smoker lung tissue, etc. In another example, the prediction may be a value (e.g., a degree of normality). The prediction model 220 may implement a machine-learning classifier, e.g., a convolutional neural network, another neural network model, or some other deep-learning architecture. The model inputs the reconstructed full-scale image to output the prediction. In a classification context, the output is a predicted label from a plurality of classification labels. For example, the model may aim to classify images of animals to determine which animal is pictured in the image. Accordingly, the output would be one of the animal labels. In a general prediction context, the output may be a predicted score. For example, the score may reflect a likelihood that the image includes a particular feature targeted for detection. Although contexts of the neural networks are described in relation image data as the input, the principles are applicable to other forms of input data. For example, the model, including the generative component and the discriminative component, can be applied to a generalized feature vector to predict a label and/or score for the feature vector.

The quality evaluation module 230 determines an aggregate classification of the input image based on the predictions for the reconstructed full-scale images. The quality evaluation module 230 may determine the aggregate classification based on a consensus of the predictions. Based on a number of predictions supporting the consensus, the quality evaluation module 230 may determine a classification confidence, e.g., as a confidence score (e.g., in the range of 1 to 100). In relation to the image generator model 210, the quality evaluation module 230 may determine a score representing the reconstruction of a synthetic image based on a seed. The score may be a structural similarity index measure (SSIM), a universal quality index (UQI), a Wang-Bovik index, or some combination thereof. The SSIM is calculated based on the two images, e.g., based on comparisons of luminance, contrast, and structure between the two images. The quality evaluation module 230 may determine a categorization of the reconstructed image based on a threshold score, e.g., above a threshold score, the quality evaluation module 230 deems the reconstructed image to be a fair representation of the input dataset, whereas below the threshold score, the quality evaluation module 230 deems the reconstructed image to be a poor representation of the input dataset. In other embodiments, the quality evaluation module 230 may leverage a deep learning model to output the score based on the two images.

In one or more embodiments, the analytics system 120 leverages the models to predict a classification label (e.g., normal tissue or anormal tissue) for an image of a tissue histology slide. The image generator model 210 generates one or more synthetic images based on the input image, and may further score reconstruction of the synthetic images based on the input image. The prediction model 220 outputs a prediction for each of the images (i.e., the input image and/or synthetic images). The quality evaluation module 230 generates a final prediction for the input image based on the predictions. For example, the quality evaluation module 230 may identify the label having the largest majority of predictions as the final prediction. In another example, with the prediction by the prediction model 220 being a value, the quality evaluation module 230 may compute an average of the predicted values. In a further example, the quality evaluation module 230 may compute weighted average of the predictions, e.g., weighted based on the reconstruction scores output by the image generator model 210.

The training module 240 trains the models implemented by the analytics system 120. The training module 240 may utilize training data, optionally, with annotated labels and/or scores. The training module 240 utilizes the training data to perform train one or more of the models as machine-learning models. In general, each model comprises a function with a plurality of parameters that transforms input data into output data. In some embodiments, each model may further be guided by an optimization algorithm to identify an optimal solution based on the function. The learned parameters and function may be stored in the datastore 260. For example, training may entail unsupervised learning, supervised learning, semi-supervised learning. Supervised learning is uses labeled examples to guide model predictions towards the ground truth labeling. Unsupervised learning, conversely, uses unlabeled examples, or at the very least ignores the label of the examples. The training module 240 feeds the model unlabeled data for the model to learn patterns in the dataset, relationships between features (e.g., latent features) in the dataset, structures of the dataset, or groupings of subsets of data within the dataset. Semi-supervised learning may combine aspects of both, using a mix of labeled and unlabeled data to leverage the limited labeled data and improve the model's ability to learn from the abundant unlabeled data. In other embodiments, semi-supervised learning leverages information within unlabeled examples to score predictions based on other examples, thereby leveraging information across different examples to guide the training of the models. The choice of learning approach depends on factors like data availability (labeled vs. unlabeled), task complexity, and the desired outcome.

In one or more embodiments, the training module 240 may train the models in a multi-stage training process. The training module 240 may train one or more of the models at each stage, while holding other models fixed. Each training stage may leverage distinct training datasets. The training module 240 may perform a first training stage to train the image generator model 210, using a first training dataset of images. The training module 240 may train the image generator model 210 with a general dataset of images. In some embodiments, the training module 240 may train the image generator model 210 with a dataset of images of normal healthy tissue (e.g., annotated by a physician or a clinician). In another stage, the training module 240 may train the prediction model 220 with labeled training data, e.g., images of tissue histology slides labeled normal or anormal (e.g., annotated by a physician or a clinician).

The user interface module 250 generates a user interface for presentation of results of the analytics system 120. The user interface module 250 may generate the user interface for access by a healthcare provider (e.g., a physician). The user interface may present one or more images of tissue histology slides. The user interface may further present the final prediction for the image (e.g., resultant from application of the one or more model of the analytics system 120). For example, one image may include the prediction that the image is predicted to be normal tissue. The user interface may further present the confidence associated with the prediction, e.g., 95% confidence. The user interface may provide further granularity into the confidence, e.g., a SSIM score for each synthetic image, etc.

In some embodiments, the user interface module 250 may augment each image with visual features demarcating different portions in the image, i.e., visually distinguishing different portions of the image. For example, the user interface module 250 may augment the image with a bounding box around a portion of the image predicted to be anormal tissue. In another example, the user interface module 250 may augment the image by coloring the portion of the image predicted to be anormal tissue one color, distinct from other portions of the image predicted to be normal tissue colored in another color, i.e., yielding a heat map for identifying anomalous tissue portions in the tissue histology slide.

### Anomalous Tissue Classification With Generative Reconstruction

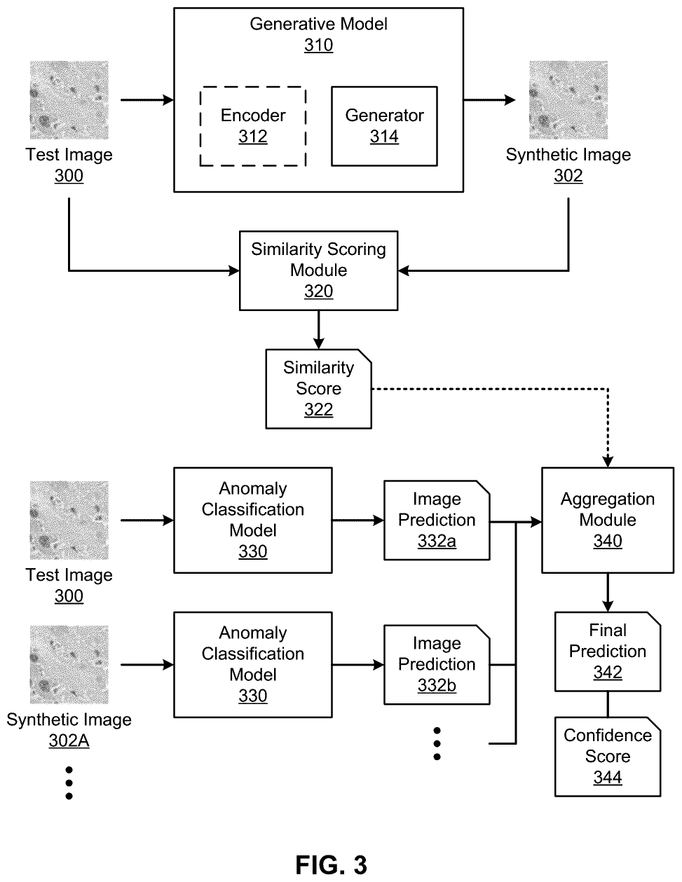

FIG. 3 illustrates a workflow for anomalous tissue classification with generative reconstruction, according to one or more embodiments. The anomalous tissue classification may be performed by an analytics system (e.g., the analytics system 120) on a test image 300 of a tissue histology slide. The workflow incorporates applying a generative model 310 and an anomaly classification model 330 to yield a final prediction 342 with a confidence score 346 providing confidence in the anomalous tissue classification workflow.

The analytics system leverages the generative model 310 to generate a plurality of synthetic images 302 based on information in the test image 300. The analytics system may apply a dropout filter to form seeds from the test image 300. The analytics system may leverage a segmentation mask to identify foreground relating to the tissue from background relating to the slide. In one example, the analytics system crops a portion of the test image 300, e.g., pertaining to the tissue, to form a seed. In some embodiments, the analytics system may use a set two-dimensional rectilinear window for cropping portions of the test image 300. In some embodiments, the analytics system may slide the cropping window across the test image, e.g., in a raster scan to generate the plurality of seeds. In some embodiments, the analytics system may use multiple cropping windows, e.g., of different size, yielding seeds of different dimensions. In some embodiments, the analytics system may use a randomized binary mask, where the information from randomized pixels is dropped out.

The analytics system then inputs each seed into the generative model 310 to generate a corresponding synthetic image 302. In some embodiments, the analytics system may feed a seed into the generative model 310 in multiple instances, to generate a multitude of synthetic images from a single seed. In such embodiments, the generative model 310 may be a probabilistic diffusion model, generating different synthetic images each time the seed is fed into the generative model 310.

In one or more embodiments, the generative model 310 is architected with an encoder 312 and a generator 314. The encoder 312 is configured to input a seed, e.g., generated from the test image 300, and to output an embedding (i.e., a latent vector or a latent matrix in a latent multi-dimensional space) representing the seed. The embedding is then fed into the generator 314 to generate the synthetic image 302.

The analytics system leverages a similarity scoring module 320 to determine a similarity score 322 between each synthetic image 302 and the test image 300. In some embodiments, the similarity scoring module 320 determines the similarity score by calculating a structural similarity index measure (SSIM). In other embodiments, the similarity scoring module 320 may calculate a pixelwise error. In some embodiments, if the similarity score 322 is below a threshold, the analytics system may exclude the synthetic image 302 from subsequent analysis. The analytics system may further generate a new synthetic image 302 in place of the excluded synthetic image, e.g., leveraging the same seed.

The analytics system then applies the anomaly classification model 330 to output an image prediction 332 for each image (i.e., the test image 300 and the synthetic images 302). For example, the anomaly classification model 330 outputs image prediction 332a for the test image 300, image prediction 332b for the synthetic image 302A, and so on with other synthetic images generated. The anomaly classification model 330 may be machine-learning model, e.g., trained for classification of whether a tissue histology image shows normal tissue or anormal tissue. In other embodiments, the anomaly classification model 330 may output, as the image prediction 332, a value indicating a likelihood the image includes normal tissue.

An aggregation module 340 of the analytics system aggregates the image predictions 332 to output a final prediction 342 and a confidence score 344. The aggregation module 340 may, in some embodiments, output the image prediction 332a for the test image 300 as the final prediction 342. In other embodiments, the aggregation module 340 may combine the image predictions 332 across the test image 300 and one or more of the synthetic images 302 to yield the final prediction 342. For example, the aggregation module 340 may identify the label of the majority of the image prediction 332 (in embodiments with classification labels as the predictions). In another example, the aggregation module 340 may average values of the image predictions 332 (in embodiments with values as the predictions). In some further examples, the aggregation module 340 may compute a weighted average, where weighting of each image prediction 332 in contribution to the final prediction 342 may be based on the similarity score 322 of the image (the test image 300 would have a maximal similarity score, given that the similarity score is determined in comparison to the test image 300).

The aggregation module 340 further outputs the confidence score 344 based on the image predictions 332 and, optionally, further based on the similarity scores 322. In some embodiments, the confidence score 344 is based on agreement of the image predictions 332. For example, if the image prediction 332a for the test image 300 indicates that the tissue is normal, the confidence score 344 may be determined as a percentage of image predictions 332 for the synthetic images 302 that concur with the label of normal. In other embodiments, the confidence score may be based on a statistical measure of the image predictions 332, e.g., a variance, a standard deviation, etc. In some embodiments, the confidence score 344 is further based on the similarity scores 322. The aggregation module 340 may combine the similarity scores 322 of the synthetic images 302 as a secondary metric to the confidence based on evaluation of the image predictions 332 in totality. For example, if primary metric (based on the image predictions 332) indicate high concurrence among the synthetic images 302 for the final prediction 342, and the secondary metric (based on the similarity scores 322) indicates high reconstruction across synthetic images 302, then the confidence score 344 for the final prediction 342 may be high. If the primary metric is high, but the secondary metric is low, the confidence score 344 for the final prediction 342 may be medium-high. If the primary metric is low, but the secondary metric is high, then the confidence score 342 may be medium-low. If the primary metric is low, and the second metric is low, then the confidence score 342 may be low.

### Example Methods

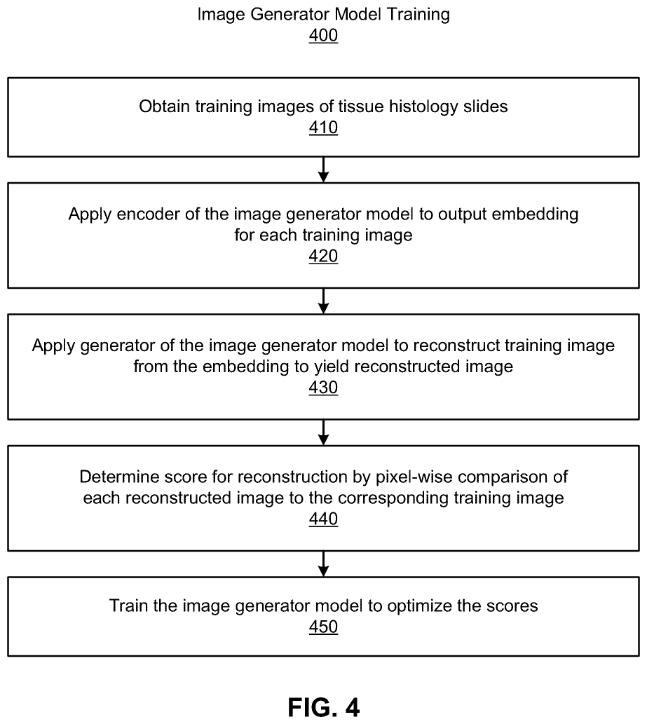

FIGS. 4-6 illustrate flowcharts related to methods related to training and/or deployment of one or more models for anomalous tissue classification in tissue histology slide images, according to one or more embodiments. The steps of FIGS. 4-6 are illustrated from the perspective of the analytics system (e.g., the analytics system 120). However, some or all of the steps may be performed by other entities or components. In addition, some embodiments may perform the steps in parallel, perform the steps in different orders, or perform different steps.

FIG. 4 illustrates a flowchart of training an image generator model, according to one or more embodiments.

The analytics system obtains 410 training images of tissue histology slides. The training images may be captured by various imaging devices. In some embodiments, the analytics system may perform some preprocessing on the training images to uniformize the data ahead of training. In some embodiments, the analytics system may use generic image data for training the image generator model.

The analytics system applies 420 an encoder of the image generator model to output an embedding for each training image. The embedding is a vector or a matrix comprising features representing the training image. The features may be abstract or latent features in a latent space. The embedding may encode information from the images, i.e., compressing dimensionality of the images.

The analytics system applies 430 a generator of the image generator model to reconstruct the training image from the embedding yielding a reconstructed image. The generator may restore dimensionality from the compressed form of the embedding.

The analytics system determines 440 a score for the reconstruction, e.g., by a pixel-wise comparison of each reconstructed image to the corresponding training image. The score may be a pixel-wise loss calculated as a difference between a pixel of the training image and a pixel of the reconstructed image.

The analytics system trains 450 the image generator model to optimize the scores, e.g., to minimize the pixel-wise loss. The analytics system may train the encoder and the generator concurrently with the scores determined from the reconstructions. In some embodiments, the image generator model is architected as a generative adversarial network.

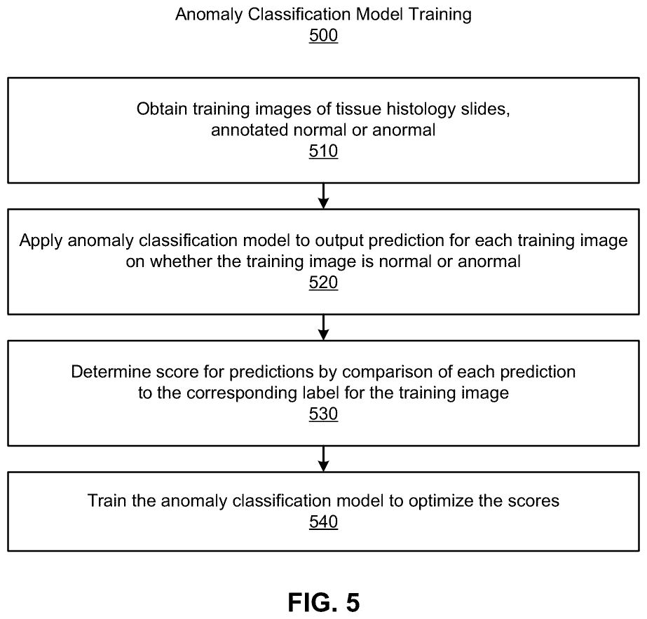

FIG. 5 illustrates a flowchart of training an anomaly classification model, according to one or more embodiments.

The analytics system obtains 510 training images of tissue histology slides, annotated as including normal tissue or anormal tissue. The training images may be demarcated by a healthcare provider, indicating portions of tissue deemed to be anormal.

The analytics system applies 520 the anomaly classification model to the training image to output a prediction of whether the training image is normal or anormal. The anomaly classification model may be architected as a deep-learning neural network, e.g., a convolutional neural network.

The analytics system determines 530 a score for each prediction by comparing the prediction to the corresponding label of the training image. For example, if the label of the training image is anormal, but the anomaly classification model predicts normal, then the score can be 0 for an incorrect prediction. On the other hand, if the label of the training image is normal (with the classification being normal), then the score can be 1 for a correct prediction.

The analytics system trains 540 the anomaly classification model to optimize the scores. Training may entail backpropagation of the score to adjust parameters of the anomaly classification model, to improve predictions by the anomaly classification model.

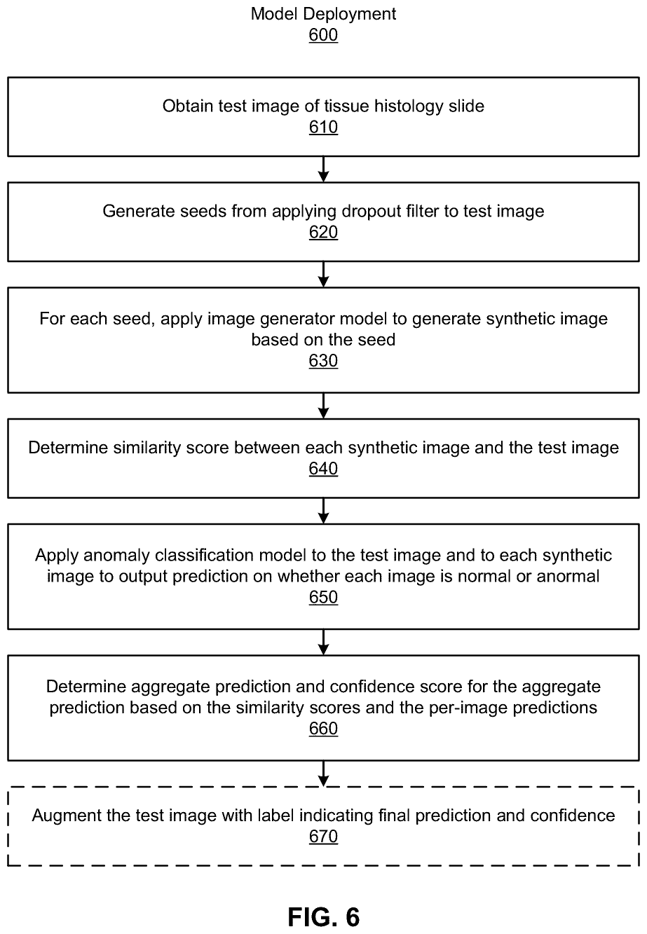

FIG. 6 illustrates a flowchart of model deployment, according to one or more embodiments. Here, the analytics system deploys the image generator model and the anomaly classification model in tandem to predict whether a test image includes normal tissue or anormal tissue.

The analytics system obtains 610 a test image of a tissue histology slide. The test image may be obtained from an imaging device, or a computer system. For example, a healthcare provider may prepare the tissue histology slide for imaging, e.g., by an imaging device. The imaging device captures the image of the tissue histology slide and provides the image to the analytics system for analysis. In other embodiments, the models may be distributed across systems, e.g., the trained models (including any functions and any weights) may be provided to a client device for execution.

The analytics system generates 620 seeds from applying a dropout filter to the test image. The analytics system leverages the seeds (as samples of information from the test image) to generate synthetic images via reconstruction from the seeds. The synthetic images are used in the anomaly classification to provide insight into confidence of the model prediction. The synthetic images can also help to pinpoint portions of tissue which are more likely anomalous compared to other portions of tissue in the test image. The analytics system may generate the seeds by applying a cropping window to extract patches from the test image. In some embodiments, the analytics system scans through the test image with the cropping window to extract patches partitioning the test image. In some embodiments, the analytics system leverages a semantic segmentation model to segment pixels into different classifications (e.g., tissue v. background). The analytics system may generate the seeds, via the dropout filter, by applying a binary mask that drops select pixel information (e.g., a random selection). In other embodiments, the mask may include gradations, for obscuring select pixel information. In one or more embodiments, the seeds are of lower dimensionality than the test image. In some embodiments, the seeds may include some seeds obtained via one filter, with other seeds obtained via another filter.

The analytics system applies 630, for each seed, an image generator model to generate a synthetic image based on the seed. For example, the image generator model may be trained according to FIG. 4. The image generator model may be trained in reconstruction, thereby generating a synthetic image that the model predicts to be the full-scale image. The image generator model may include an encoder and a generator, where the encoder encodes the seed into an embedding (i.e., a latent vector), whereas the generator reconstructs the synthetic image from the embedding.

The analytics system determines 640 a similarity score between each synthetic image and the test image. The analytics system may determine the similarity score by computing a structural similarity index measure. Other metrics may be used. In some embodiments, the analytics system may filter out synthetic images with a below-threshold score. The analytics system can generate replacement synthetic images, or proceed with the filtered set.

The analytics system applies 650 an anomaly classification model to the test image and to each synthetic image to output a prediction on whether each image includes normal tissue or anormal tissue. The anomaly classification model may be trained according to FIG. 5. The prediction may be a classification label, or a value.

The analytics system determines 660 a final prediction for the test image and a confidence associated with the final prediction based on the predictions for the images and, optionally, the similarity scores for the synthetic images. In one example, the analytics system may identify a majority consensus among the predictions as the final prediction. In another example, the analytics system may combine the predictions to yield the final prediction (e.g., average, weighted average, etc.). In another example, the final prediction is the prediction for the test image. The confidence provides insight into the final prediction. In one example, the analytics system computes the confidence based on consensus of the predictions for the synthetic images with the prediction for the test image (or the final prediction). In another example, the analytics system computes the confidence further based on the similarity scores, e.g., via a weighted average. In another example, the analytics system may compute a first metric associated with the predictions from the synthetic images (and, optionally, the test image), and a second metric associated with the similarity scores for the synthetic images. The confidence may include the two metrics, or may combine the two metrics into an aggregate confidence metric.

The analytics system may augment 670 the test image with a label indicating the final prediction and the confidence. In some embodiments, the label may be a text label overlayed on the test image. In other embodiments, the label may be a visual demarcation indicating the final prediction and the confidence. In other embodiments, the label may be a visual demarcation indicating particular portions of tissue likely to be anomalous. In such embodiments, the analytics system may keep track of which seed patches were predicted to be anormal. The analytics system may determine those seed patches to be the locale of the anomalous tissue in the test image, e.g., like a heat map where the normal tissue is colored one way and the anormal tissue is colored another way. The analytics system may present the augmented test image in a user interface to a healthcare provider, e.g., on a client device operated by the healthcare provider.

### Example Results

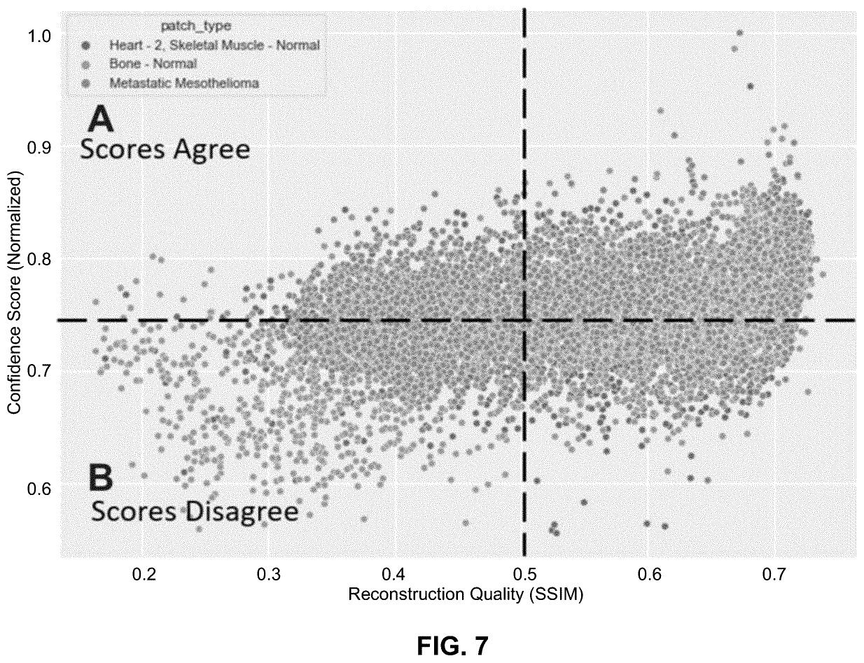

FIG. 7 is a plot of confidence output by the models for a validation set of images, according to one or more example implementations. The validation set includes three different groupings of images, a first grouping for normal tissue from heart and/or skeletal muscle, a second grouping for normal tissue from bone, and a third grouping for anormal tissue from metastatic mesothelioma. The model outputs the two metrics for confidence, the confidence score (normalized) based on the concordance of the synthetic image predictions, and the reconstruction quality (SSIM) based on the similarity scores assessing reconstruction of the synthetic images. Generally, the confidence scores plotted are above 0.5, with the reconstruction quality ranging from ˜0.15 to ˜0.75. In the top left quadrant, the two metrics agree, that the synthetic images are anormal. In the bottom left quadrant, the two metrics disagree, with the confidence suggesting normal tissue, but the reconstruction suggesting anormal. This plot highlights the advantage of leveraging the generative reconstruction from seeds of a test image to output at least one metric indicating confidence in the anomaly classification.

### Computing System Architecture

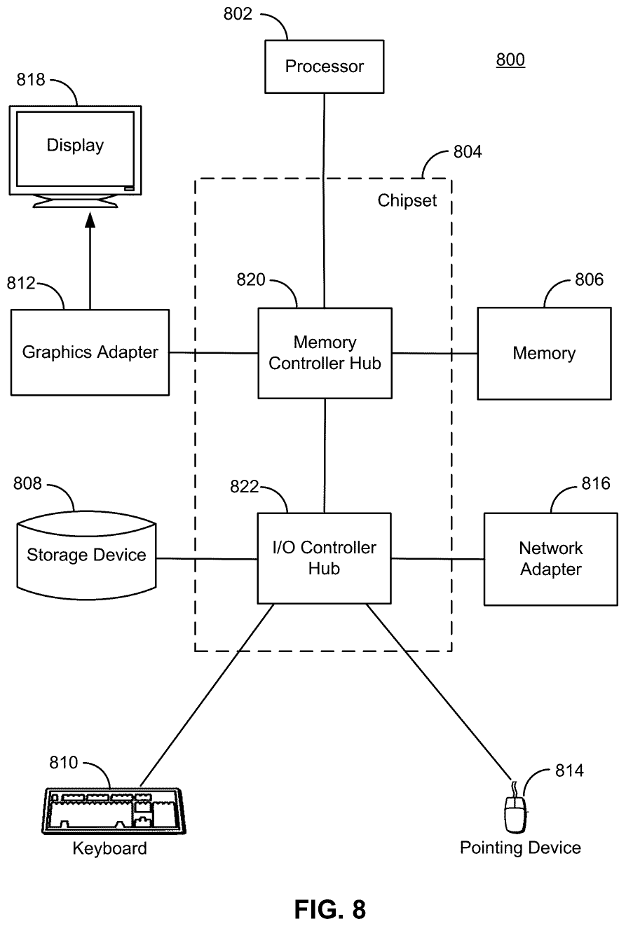

FIG. 8 is a block diagram of an example computer 800 suitable for use in the networked computing environment 100. The example computer 800 includes at least one processor 802 coupled to a chipset 804. The chipset 804 includes a memory controller hub 820 and an input/output (I/O) controller hub 822. A memory 806 and a graphics adapter 812 are coupled to the memory controller hub 820, and a display 818 is coupled to the graphics adapter 812. A storage device 808, keyboard 810, pointing device 814, and network adapter 816 are coupled to the I/O controller hub 822. Other embodiments of the computer 800 have different architectures.

In the embodiment shown in FIG. 8, the storage device 808 is a non-transitory computer-readable storage medium such as a hard drive, compact disk read-only memory (CD-ROM), DVD, or a solid-state memory device. The memory 806 holds instructions and data used by the processor 802. The pointing device 814 is a mouse, track ball, touchscreen, or other type of pointing device, and may be used in combination with the keyboard 810 (which may be an on-screen keyboard) to input data into the computer system 800. The graphics adapter 812 displays images and other information on the display 818. The network adapter 816 couples the computer system 800 to one or more computer networks, such as network 140.

The types of computers used by the entities of FIGS. 1 and 2 can vary depending upon the embodiment and the processing power required by the entity. For example, the analytics system 120 might include multiple blade servers working together to provide the functionality described while a client device 130 might be a tablet or laptop. Furthermore, the computers can lack some of the components described above, such as keyboards 810, graphics adapters 812, and displays 818.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for automatically classifying subvisible particles. Thus, while particular embodiments and applications have been illustrated and described, it is to be understood that the described subject matter is not limited to the precise construction and components disclosed. The scope of protection should be limited only by any claims that may ultimately issue.

What is claimed is:

1. A computer-implemented method of determining model confidence, the method comprising:
obtaining a test image of a tissue histology slide;
generating seeds from applying a dropout filter to the test image;
generating, for each seed, a synthetic image by applying an image generator model to the seed;
applying a prediction model to the test image to generate a prediction for the test image of whether the tissue is normal or anormal;
applying the prediction model to each synthetic image to generate a prediction for the synthetic image of whether the tissue is normal or anormal;
determining a final prediction for the test image and a confidence associated with the final prediction based on the predictions for the test image and the synthetic images; and
augmenting the test image with a label indicating the final prediction and the confidence associated with the final prediction.

2. The computer-implemented method of claim 1, wherein generating the seeds from applying the dropout filter to the test image comprises:
applying a cropping window to extract patches of the test image, wherein each patch is one seed.

3. The computer-implemented method of claim 2, further comprising:
applying a semantic segmentation model to the test image to segment pixels belonging to tissue from pixels belonging to background in the test image,
wherein applying the cropping window comprises applying the cropping window over pixels segmented as belonging to tissue.

4. The computer-implemented method of claim 1, wherein generating the seeds from applying the dropout filter to the test image comprises:
applying a binary mask to dropout pixels from the test image to generate one seed.

5. The computer-implemented method of claim 1, further comprising:
determining a similarity score for each synthetic image by comparing the synthetic image to the test image,
wherein determining the confidence associated with the final prediction is further based on the similarity scores for the synthetic images.

6. The computer-implemented method of claim 5, further comprising:
filtering one or more of the synthetic images having similarity score below a threshold score, yielding a subset of synthetic images,
wherein applying the prediction model comprises applying the prediction model to each synthetic image in the subset of synthetic images.

7. The computer-implemented method of claim 1, wherein applying the image generator model comprises:
inputting the seed into an encoder of the image generator model to output an embedding for the seed; and
inputting the embedding into a generator of the image generator model to output the synthetic image from the embedding.

8. The computer-implemented method of claim 7, wherein the generator is a generative adversarial network, an autoencoder, a diffusion model, an autoregressive model, or a flow-based model.

9. The computer-implemented method of claim 7, wherein the image generator model is trained by:
obtaining training data comprising training images of normal tissue;
for each training image:
inputting the training image into the encoder to output an embedding for the training image,
inputting the embedding for the training image into the generator to output a reconstruction of the training image, and
determining a loss between the reconstruction and the training image; and
training the encoder and the generator of the image generator model as a machine-learning model with the losses for the training data.

10. The computer-implemented method of claim 1, wherein the prediction model is trained by:
obtaining training data comprising training images of tissue histology slides, each training image including a label of normal tissue or anormal tissue;
for each training image:
inputting the training image into the prediction model to output a prediction of whether the training image includes normal tissue or anormal tissue, and
determining a loss between the prediction and the label for the training image; and
training the prediction model as a machine-learning model with the losses for the training data.

11. The computer-implemented method of claim 1,
wherein determining the final prediction for the test image comprises aggregating the predictions for the test image and the synthetic images to yield the final, and
wherein determining the confidence associated with the final prediction comprises identifying a percentage of synthetic images with predictions in agreement with the final prediction as the confidence.

12. The computer-implemented method of claim 1, further comprising:
identifying portions of the test image predicted to be anormal tissue based on the predictions for the synthetic images,
wherein augmenting the test image comprises demarcating the portions of the test image predicted to be anormal tissue.

13. A non-transitory computer-readable storage medium storing instructions that, when executed by a processor, cause the processor to perform operations comprising:
obtaining a test image of a tissue histology slide;
generating seeds from applying a dropout filter to the test image;
generating, for each seed, a synthetic image by applying an image generator model to the seed;
applying a prediction model to the test image to generate a prediction for the test image of whether the tissue is normal or anormal;
applying the prediction model to each synthetic image to generate a prediction for the synthetic image of whether the tissue is normal or anormal;
determining a final prediction for the test image and a confidence associated with the final prediction based on the predictions for the test image and the synthetic images; and
augmenting the test image with a label indicating the final prediction and the confidence associated with the final prediction.

14. The non-transitory computer-readable storage medium of claim 13, wherein generating the seeds from applying the dropout filter to the test image comprises:
applying a cropping window to extract patches of the test image, wherein each patch is one seed.

15. The non-transitory computer-readable storage medium of claim 13, wherein generating the seeds from applying the dropout filter to the test image comprises:
applying a binary mask to dropout pixels from the test image to generate one seed.

16. The non-transitory computer-readable storage medium of claim 15, the operations further comprising:
determining a similarity score for each synthetic image by comparing the synthetic image to the test image,
wherein determining the confidence associated with the final prediction is further based on the similarity scores for the synthetic images.

17. The non-transitory computer-readable storage medium of claim 13, wherein applying the image generator model comprises:
inputting the seed into an encoder of the image generator model to output an embedding for the seed; and
inputting the embedding into a generator of the image generator model to output the synthetic image from the embedding.

18. The non-transitory computer-readable storage medium of claim 13,
wherein determining the final prediction for the test image comprises aggregating the predictions for the test image and the synthetic images to yield the final, and
wherein determining the confidence associated with the final prediction comprises identifying a percentage of synthetic images with predictions in agreement with the final prediction as the confidence.

19. The non-transitory computer-readable storage medium of claim 13, the operations further comprising:
identifying portions of the test image predicted to be anormal tissue based on the predictions for the synthetic images,
wherein augmenting the test image comprises demarcating the portions of the test image predicted to be anormal tissue.

20. A system comprising:
a processor; and
a non-transitory computer-readable storage medium storing instructions that, when executed by the processor, cause the processor to perform operations comprising:
obtaining a test image of a tissue histology slide;
generating seeds from applying a dropout filter to the test image;
generating, for each seed, a synthetic image by applying an image generator model to the seed;
applying a prediction model to the test image to generate a prediction for the test image of whether the tissue is normal or anormal;
applying the prediction model to each synthetic image to generate a prediction for the synthetic image of whether the tissue is normal or anormal;
determining a final prediction for the test image and a confidence associated with the final prediction based on the predictions for the test image and the synthetic images; and
augmenting the test image with a label indicating the final prediction and the confidence associated with the final prediction.
